(19) United States
(12) Patent Application Publication
(10) Pub. No.: US 2011/0031188 A1
(43) Pub. Date: Feb. 10, 2011

(54) Humic Derivatives Methods of Preparation and Use

(76) Inventors: Irina Vasilyevna Perminova, Moscow (RU); Sergey Anatolievich Ponomarenko, Moscow (RU); Leonid Alexandrovich Karpiouk, Moscow (RU); Kirk Hatfield, Gainesville, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/086,504

(22) PCT Filed: Mar. 7, 2006
(86) PCT No.: PCT/RU2006/000102

§ 371 Date: Sep. 9, 2010

(51) Int. Cl. B09C 1/00; C07F 7/10

(52) U.S. Cl. 210/747; 544/69

(57) ABSTRACT

Humic derivatives are prepared and used to adhere to the surfaces of mineral media and other hydroxyl-carrying supports for cleaning the environment by selective sequestration of complex mixtures of contaminants possessing preferential affinity for natural or modified humic substances (HS). The sequestration of target components occurs as a result of their binding to dissolved humic derivatives that can be removed from the solution by adding any solid hydroxyl-carrying support (e.g., silica gel). Another method to sequester the target components from solution is their selective sorption onto humic derivatives immobilized onto solid support (e.g., silica gel). Yet another method involves using the humic derivatives to install a broad spectrum reactive barrier without excavation as an in situ passive remediation system.

### FIELD OF INVENTION

Our invention is related to the chemistry of humic and organo-elemental compounds and is directed to methods for cleaning the environment by selective sequestration of complex mixtures of contaminants possessing preferential affinity for modified humic substances (HS). In particular, our invention uses soluble humic derivatives that have been specifically modified to adhere to the surfaces of the mineral media and other hydroxyl-carrying supports. The sequestration of target components occurs as a result of their binding to dissolved humic derivatives that can be removed from the solution by adding any solid hydroxyl-carrying support (e.g., silica gel). Another method to sequester the target components from solution is their selective sorption onto humic derivatives immobilized onto solid support (e.g., silica gel). Yet another method involves using the HS derivatives to install a broad spectrum reactive barrier without excavation as an in situ passive remediation system. Components that have preferential affinity for HS include heavy metals, radionuclides, polycyclic aromatic hydrocarbons, pesticides, chlorinated hydrocarbons, azodyes, and other chemicals generally present is environmental contaminants at a variety of sites. In addition, the components can include biologically active compounds such as antibiotics and other pharmaceuticals, bacterial toxins, e.g., endotoxin.

### BACKGROUND OF THE INVENTION

Heavy metal and organic contamination of soils, buildings and equipment systems is a major environmental concern at both industrial and government sites. The contamination is primarily due to improperly disposed industrial wastes. The presence of toxic heavy metal ions, volatile organic compounds and pesticides in the environment is of great concern and could affect worker safety as well as the safety of drinking water and air for the general public.

It is known in the art to use unmodified HS to treat environmental contaminants. HS are ubiquitous in the environment and comprise the most abundant pool of non-living organic matter. Humic materials are typically derived on an industrial scale from peat, sapropel, and coal. The richest source of HS is leonardite, a soft brown coal-like deposit usually found in conjunction with deposits of lignite. Leonardite is the most widely used raw material for production of commercial humic preparations followed by other low-rank coals, peat, and sapropel. Hence, the reserves of inexpensive humics-rich materials are immense; however, these reserves are not currently being tapped for practical needs.

A peculiar feature of HS is its polyfunctionality, which enables them to interact with both metal ions and organic chemicals. The palette of potential interactions includes ion-exchange, complexation, redox transformations, hydrophobic bonding, etc. As a result, numerous studies have shown humics capable of altering both the chemical and the physical speciation of the contaminants and in turn affecting their bioavailability and toxicity. As such, HS hold great promise to function as amendments to mitigate the environmental impacts of contaminants and as active agents in remediation. In particular, the capability of HS to bind different chemical compounds (both organic and inorganic) can be used to sequester contaminants from aqueous solutions. It can be also used for separating complex mixtures of chemicals according to their affinity for HS. Only those chemicals that have a preferential affinity for HS will be sequestered.

Remediation of contaminated ground water is most commonly accomplished using “pump and treat,” followed by disposal or re-injection of the treated water. This process can be costly and inefficient due to difficulties arising from the ineffective capture of contaminated ground waters and the sorption of contaminants on mineral surfaces. Permeable reactive barriers (PRB) are an alternative to “pump & treat” systems and receive a great deal of attention as an innovative cost-effective technology for in situ clean up of groundwater contamination. A PRB is a subsurface wall of reactive permeable media emplaced across the flow path of a contaminant plume. The plume is allowed to migrate passively through the PRB and in the process contaminants are precipitated, sorbed, or degraded. A PRB could also be emplaced in a horizontal orientation for purposes of intercepting dissolved contaminants in recharge or vertical infiltration. A typical PRB is costly to install but economical to maintain. Much of the installation cost is related to the excavation of aquifer material that is then replaced with reactive porous media; furthermore, these systems are typically over-designed to address uncertainties in groundwater flow and to accommodate an anticipated loss of treatment efficiency with time. PRBs are filled with different reactive materials such as metals or metal-based catalysts for degrading volatile organics, chelators or ion exchangers for immobilizing metal ions, nutrients and oxygen for microorganisms to enhance bioremediation, or other agents. The reactions that take place in barriers are dependent upon parameters such as pH, oxidation/reduction potential (Eₕ), concentrations, and kinetics. Reactive materials used must demonstrate sufficiently rapid kinetics to remove target contaminants from aquifer recharge or ground water under natural gradient conditions. In addition, these reactive materials must be inexpensive and functional over an extended time horizon. Finally, pertinent chemical reactions must not produce and release toxic by-products. To date, only a limited number of reactive materials satisfy these restrictions including zero valent iron (ZVI)—the most frequently utilized medium, zeolites, peat, lime and ferric oxyhydroxide.

HS have shown promise as refractory and as inexpensive reactive components for PRB. This is particularly true wherever remediation involves a complex array of contaminants, and the reactive material must treat both soluble heavy metals and hydrophobic organics. The applications of humic adsorbents for one-pass removing contaminants of different chemical nature, such as heavy metals and organic chemicals, are described in U.S. Pat. Nos. 6,143,692 and 5,906,960. Although using the insolubilized cross-linked adsorbent is feasible as a reactive material for an “excavation” PRB, it is not applicable for an in situ installation. The same is true for the humic fluid reagent that is immobilized only onto organic solid support, which has no applicability to use in aquifers, soils or sediments.

In situ installation of unmodified humic PRBs is described in U.S. Pat. No. 5,520,482 and its related foreign counterparts. The PRB is installed using a two-step process: the water solution of alkaline humates is pumped under ground, followed by pumping solution of acids or di- or trivalent metal salts; or direct injection of humates mixed with metal salts, such as Ca, Mg, and Fe, into an aquifer is used. The disadvantage of this method is the high sensitivity of this PRB to any alterations in pH and Eh of the aquifer. This is because the humic layer that is immobilized on the mineral support is comprised of protonated humic acid or humic complexes with di- and tri-valent metals, and the solubility of these compounds depends greatly on pH and Eₕ of their environment. A drop in Eₕ can bring about a reduction of Fe(III) to Fe(II) which has much lower stability constants with HS as compared to Fe(III). An increase in pH will favor dissolution of precipitated humic acid. In addition, pumping in solutions of mineral acids and salts under the ground can lead to secondary contamination of ground water. Also known to those in the art is immobilizing humic polyanions by reverting the negative charge of mineral support (sand). In this application it was necessary to subsequently coat the sand with iron(III) and humics. The main disadvantage of the above techniques is high sensitivity of HS-coating formed by metal-bridges to any changes in pH and Eₕ of aquifer that prevents their wide use in practice.

Although the prior art has recognized a number of substances and methods to remediate environmental contaminants, including the use of HS, improvements in this area are needed. As described further below, we have created new HS derivative compounds that lead to the formation of functionalized humic macromolecules, which are water soluble, but are readily transferred into the solid phase by adding silica gel or other solid support containing hydroxyl-groups at the surface. These HS derivatives can be used to form stable PRBs as will be explained in detail below.

### SUMMARY OF THE INVENTION

Our invention relates generally to a new class of compounds, namely humic derivatives that are specifically modified to adhere to surfaces of mineral and other hydroxyl-carrying solid supports and that can be used either in the soluble or immobilized form.

Accordingly, one of the objects of our invention is to provide novel humic derivatives, methods of their manufacture, and methods of sequestration of dissolved components possessing preferential affinity for natural or modified humic substances.

It is also an object of the present invention to provide a method for in situ installing reactive barrier to remove organic compounds and metal ions, when present, either singly or in combination, from contaminated water, such as ground water, surface water, soil leachates, recharge, and intersticial water in sediments, or contaminated sites such as soil, oil exploration and production sites and similar sites.

It is another object of the present invention to provide humic derivatives for in situ installation of reactive barrier which sorb irreversibly on mineral support by forming covalent bonding with OH-containing mineral surfaces that precludes facile mobilization of the humic coating and the contaminants entrapped within that coating, and provides for chemical stability of the installed humic barrier.

Still another object of the present innovation is to provide a method for synthesis of the self-adhering humic agent, which facilitates in situ installation of the reactive barrier in contaminated sites such as aquifer, soil, and sediments.

We unexpectedly determined that treatment of HS with alkoxyorganosilanes would lead to formation of functionalized humic macromolecules, which were water soluble, but could be readily transferred into solid phase by adding their solution to silica gel or other mineral solid support containing hydroxyl-groups at the surface. This phase switch occurs due to the high affinity of the alkoxysilyl-groups incorporated into humic macromolecules for hydroxyl-carrying mineral solid supports. Upon hydrolysis of alkoxysilyl-groups, after the alkoxysilyl-derivative is dissolved in water, reactive silanol-groups in the structure of humic derivative are produced. The produced dissolved silanol-derivative binds covalently to hydroxyl-containing surface sequestering humic macromolecule and binds to it target contaminants from a given solution.

In particular, our invention covers alkoxysilyl-humic derivatives as soluble supports or sequestration-enabling agents for removal of contaminants possessing an affinity for HS from solution by adding a hydroxyl-containing solid support. The latter can be separated from solution by filtration. At the same time, alkoxysilyl-derivatives immobilized onto surface of a solid support (e.g., silica gel) can be used as scavengers for sequestration of components of the mixtures with preferential affinity for HS.

Another advantage of utilizing humic derivatives for remediation technologies is the availability of inexpensive and plentiful raw materials to formulate the humic derivatives of our invention. In particular, different varieties of coal, peat, sapropel, shale kerogen, composts, and other like substances can be used. The HS starting material can be used both in protonated form (humic acids and fulvic acids), as salts (humates and fulvates), and as preliminary modified derivatives enriched with different functional groups. In addition to above humic materials, other humic-like substances containing materials such as composts and biohumus can be used as raw materials, as well as other carbonaceous materials containing organic compounds rich with carboxyl, carbonyl and hydroxyl-groups such as microbial degradation products of lignin, wood, and coal, or similar microbial synthesis products, or lignosulfonates or tannnins, chitosans, and other like material. Given that HS have no stoichiometric composition and regular structure, they are characterized by the content of main constitutive elements. As such, we understand that unmodified HS include compounds that contain the following elements; about 20 to about 70 wt. % C, about 2 to about 10 wt. % H, about 15 to about 55 wt. % O, about 0 to about 10 wt. % N, and may contain about 0 to about 10 wt. % S and about 0 to about 50 wt. % ash. In addition, these compounds can contain from about 1 to about 15 mmol/g of carboxyl groups, from about 1 to about 10 mmol/g of hydroxyl groups, and from about 0.5 to 10 mmol/g of carbonyl groups. In preparing the humic derivatives of our invention, organosilanes with different functional groups able of reacting with main functional groups of HS (the latter are carboxyl, hydroxyl and carbonyl) can be used. By organosilanes we mean alkoxysilanes having one functional organic group separated from the Si atom by at least one, preferably by three methylenic units, and at least one, preferably three alkoxy-substituents. By functional groups in organosilane we understand those groups, which can react with the main functional groups of HS, and include, but not limited to amino, epoxy and isocyanato groups.

The present invention is also directed to new methods that can be used for installing a broad spectrum reactive barrier without excavation as an in situ passive remediation system. The proposed innovative technology uses soluble humic derivatives that have been specifically modified to adhere irreversibly to the surfaces of the mineral media. The reactive media of the barrier is created in situ by means of injecting a solution of dissolved humic derivative, which can be used to remove metals, radionuclides, and/or organic materials generally present as environmental contaminants at a variety of sites. The produced humic coating is covalently bound to mineral surfaces. The particular advantage of covalently bound humic coating is stability to changes in acid-base or redox environmental conditions that prevents facile liberation of entrapped contaminants. Until now, the art has not recognized the feasibility of preparing soluble humic derivative able to self-adhere to mineral surfaces under aquifer conditions. Particularly unexpected was the use of alkoxysilyl-humic derivatives as reactive agents. It is the silanol-groups, not the alkoxysilyl-groups that are able to form covalent Si—O—Si or Si—O-M bonding (where M is a metal) after reacting with hydroxyl-groups containing mineral surfaces. However, silanol-derivatives easily polymerize with formation of insoluble cross-linked siloxane-polymers and this characteristic makes their practical utilization impossible. We have found that reactive silanol-groups in the structure of humic derivative are produced upon hydrolysis of alkoxysilyl-groups, after the alkoxysilyl-derivative is dissolved in water. The on-site produced dissolved silanol-derivative binds covalently to mineral surface forming irreversibly bound humic coating. The advantage of humic coating is a broad-spectrum reactivity of HS that facilitates immobilization of both metal ions and organic contaminants within same reactive media.

The reactive media of the humic barrier is created in situ by means of injecting a solution of humic derivatives, e.g., a fencerow of injection wells can be used to install a permeable reactive barrier (PRB) of reactive humic derivative immobilized on granular porous media of the contaminated aquifer. Formation of covalent bonding between humic derivatives and mineral support can be seen as a particular advantage of the proposed approach; as it precludes facile mobilization of the humic coating and the contaminants entrapped within that coating. To install reactive barrier in situ according to the present invention, self-adhering humic derivatives are dissolved in water and the obtained solution is injected into contaminated aquifer, soil, or sediments.

According to our invention, a method is provided for in situ installation of reactive humic barrier that can be used as passive remediation system to treat organic compounds or both organics and metal ions, when present, either singly or in combination. As compared to conventional methods of PRB installation, which include excavation of aquifer material or separate pumping steps using, e.g., soluble hamate injection followed by injection of precipitating agent (e.g. acid or di- and trivalent metal salts) or vise versa, the process of our invention is less expensive and easier for treating all types of process streams. To install the reactive barrier in situ according to our invention, self-adhering humic derivatives are dissolved in water and the obtained solution is injected into contaminated aquifer, soil, or sediments.

To prepare the self-adhering humic derivatives according to the present invention, solid humic material is reacted with organosilane (e.g., 3-aminopropyltrimethoxysilane, APTS) in an organic solvent (e.g., DMF). Then, the solvent is evaporated and the product is isolated. The obtained humic substance can be defined as alkoxysilylated humic derivative. It differs from parent humic material in physical-chemical properties, and elemental and functional composition. The alkoxysilylated humic derivatives contain (wt %): Si 2-12; C 25-68, H 2-10, and N 0-15. In some formulations the humic derivatives may contain sulfur in the range from about 0 to about 15 wt. %. It can be solubilized in water and immobilized irreversibly on mineral and other hydroxyl-carrying solid supports.

### BRIEF DESCRIPTION OF THE DRAWINGS

FIG. 1 shows FTIR-spectra of parental leonardite HA, APTS, and HA-APTS-derivative.

FIG. 2 shows ¹³C NMR spectra of parental leonardite HA and HA-APTS-derivative.

FIG. 3 shows FTIR-spectra of parental leonardite HA and HA-GPTS-derivative.

FIG. 4 shows FTIR-spectra of parental hydroquinone-modified HA (HQ), APTS and HQ-APTS-derivative.

FIG. 5 shows sequestration of liquid-phase HA-APTS by silica gel (phosphate buffer, pH 6.8).

FIG. 6 shows FTIR-spectrum of humic alkoxysilyl-derivatives immobilized on silica gel (HA-APTS-SiO₂).

FIG. 7 shows sequestration kinetics of Np(V) in the presence of solid scavenger I (HA-APTS-SiO2) containing not enriched leonardite HA and of scavenger II (HQ-APTS-SiO₂) containing hydroquinone enriched leonardite HA at pH 4.5.

FIG. 8 shows sequestration of lipopolysaccharide (LPS) by solid humic scavenger I (HA-APTS-SiO2) as compared to pure silica gel

### DETAILED DESCRIPTION OF THE INVENTION

Our invention relates to soluble humic derivatives that are formulated such that they are capable of irreversible sorption on solid supports. To achieve this result humic macromolecules are functionalized by treating them with alkoxyorganosilanes whereby alkoxysilyl-groups are attached and upon hydrolysis produce silanol-groups reacting with hydroxyl-carrying surfaces with the formation of covalent Si—O—Si or Si—O-M bonds.

Any known raw humic or humic-like material can be used as a starting material in our invention. These include different varieties of coal, peat, sapropel, shale kerogen, composts, and others. These HS can be used both in protonated form (humic acids and fulvic acids), as salts (humates and fulvates), and as preliminary modified derivatives enriched with different functional groups. In addition to above humic materials, other humic-like substances containing materials such as composts and biohumus can be used as raw materials, as well as other carbonaceous materials containing organic compounds rich with carboxyl, carbonyl and hydroxyl-groups such as microbial degradation products of lignin, wood, and coal, or similar microbial synthesis products, or lignosulfonates, or tannins, or chitosans, and others. Because HS have no one stoichiometric composition or standard chemical structure, they are characterized by the content of their main constitutive elements. Accordingly, as used herein HS will mean compounds that contain (on ash free basis) about 20 to about 70 wt. % C, about 2 to about 10 wt. % H, about 15 to about 55 wt. % O, about 0 to about 10 wt. % N, and about 0 to about 50 wt. % ash. In some formulations HS contains about 0 to about 10 wt. % S.

The mineral support to which the HS derivatives of our invention are bound should have hydroxyl- or oxide-containing surfaces. These mineral supports include silica gel, sand, quartz, alumosilicates, clays, aluminum hydroxide, aluminum, diatomite, calcite, inorganic oxides (e.g., Al₂O₃, Fe₂O₃, TiO₂, Cr₂O₃), glass tissues, mineral cotton, asbestos, pigments, vermiculite, vollastonite, different granular supports (stones, bricks), and other like materials. Most preferred are supports that lend themselves to modification of Si—OH-containing surfaces.

As mentioned, the HS are modified using organosilanes containing functional groups able to react with functional groups on the HS. The preferred types of organosilanes that can be used to prepare the HS derivatives of our invention are listed in Table 1. By alkoxygroups we mean groups containing from 1 to 20 atoms of carbon. Preferably, the use of methoxy- and ethoxy-silanes is desired because of their higher rate of hydrolysis and, hence, higher rate of interaction with OH-groups on the surface of solid mineral support. For the purpose of this invention one can use organosilanes having one, two or three alkoxygroups, named as mono-, di- or trialkoxysilanes, or their mixtures. Thus, functional organosilanes in question include, but not limited to 3-aminopropyl-dimethylmethoxy-silane, 3-amino-propylmethyldimethoxy-silane, 3-amino-propyltrimethoxy-silane, 3-amino-propyldimethylethoxy-silane, 3-amino-propylmethyldiethoxy-silane, 3-amino-propyltriethoxy-silane, 3-glycidoxy-propyldimethylmethoxy-silane, 3-glycidoxy-propylmethyldimethoxy-silane, 3-glycidoxy-propyltrimethoxy-silane, 3-glycidoxy-propyldimethylethoxy-silane, 3-glycidoxy-propylmethyldiethoxy-silane, 3-glycidoxy-propyltriethoxy-silane, 3-isocyanato-propyldimethylmethoxy-silane, 3-isocyanato-propylmethyldimethoxy-silane, 3-isocyanato-propyltrimethoxy-silane, 3-isocyanato-propyldimethylethoxy-silane, 3-isocyanato-propylmethyldiethoxy-silane, 3-isocyanato-propyltriethoxy-silane. It is preferable to use trialkoxysilanes, since attaching of one functional trialkoxysilane to HS gives three reactive alkoxygroups, thus producing humic derivatives of the highest affinity to hydroxy-containing supports. However, this invention does not exclude usage of mono- or dialkoxysilanes or their mixtures together or with trialkoxysilanes in any ratio for the modification of HS.

Unexpectedly we found that after organosilane treatment, the HS remain water soluble, which enables the use of these resultant alkoxysilyl-derivatives as macromolecular silylating agents. The alkoxysilyl-humic derivatives of our invention have never been described or disclosed in the art. The resultant derivatives differ substantially from the starting HS in elemental and functional composition as well as in their ability to sorb onto mineral and other OH— and —O— containing surfaces. The differences in the composition and properties of the derivatives and the starting materials were demonstrated using a number of chemical-physical methods including elemental analysis, titrimetry, FTIR and ¹³C NMR-spectroscopy.

TABLE 1
Organosilanes, which can be used for modification of humic substances

| Functionality | Name | Structure |
|---|---|---|
| Amino | 3-aminopropyltrialkoxysilane | H₂N(CH₂)₃Si(OR)₃ |
| | (APTS) | |
| Epoxy | 3-glycidoxy-propyltrialkoxy- silane (GPTS) | 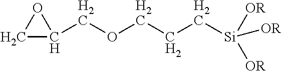 |
| Sulfur | bis-(trialkoxy -silylpropyl) | (RO)₃Si(CH₂)₃S₄(CH₂)₃Si(OR)₃ |
| | tetrasulfan-silane | |
| Sulfur | 3-mercapto-propyltrialkoxy- | HSCH₂CH₂CH₂Si(OR)₃ |
| | silane | |
| Isocyanate | 3-isocyanato-propyltrialkoxy- | OCN(CH₂)₃Si(OR)₃ |
| | silane | |
| Methacryloxy | 3-methacryloxy-trialkoxy-silane | CH₂═(CH₃)CO₂(CH₂)₃Si(OR)₃ |

The alkoxysilyl-humic derivatives of our invention are characterized by the following compositions and properties. Their elemental composition satisfies the following ranges (wt. %): Si 2-12; C 25-68, H 2-10, and N 0-15. They contain from 0.1 to 15 mmol of alkoxysilyl-groups per gram of HS depending on the selected modification degree of the functional groups of HS. They can be solubilized in water and immobilized irreversibly on OH-containing solid support.
Preparation of our alkoxysilyl-humic derivatives is accomplished using the following method:
1. The starting solid humic material is first homogenized.
2. The homogenized HS is reacted with an organosilane, preferably in an organic solvent, with heating at about 30-150° C., and at a molar ratio of functional groups of the reagents (organosilane:HS) from about 0.1:1 up to about 2:1.
3. The obtained derivative is then separated from the solvent (e.g., using rotor evaporation).
4. The obtained derivative is dried in vacuum oven at about 25 to about 150° C.
Using the novel alkoxysilyl-humic derivatives of our invention we have found that liquid-phase scavenger compounds can be prepared and used in remediation efforts, in particular to sequester environmental contaminants. These scavengers can be prepared using the following method:
1. A solid humic derivative prepared as described above is homogenized and mixed with concentrated alkali solution (from about 1 to about 50%) at a ratio from 1:1 to 1:5 (V/V).
2. The alkaline derivative solution is then diluted with water to create a concentration between 0.1 and 10% and (if necessary) is acidified to pH 5-6.
3. Preferably the resultant solution is used within a time interval from about 1 to about 240 hours of formulation (to allow for initial hydrolysis of alkoxysilyl-groups for an hour and to escape polymerization of silanol-groups, which occurs after about 240 hours).
4. The solution of alkoxysilyl-derivatives is mixed with a weight of silica gel.
5. The obtained suspension is mixed for about 4 to about 120 hours.
6. The silica gel with humic derivative coating is separated from solution using filtration.
Once the scavengers, as described above, are prepared, they can be used as sequestering agents for contaminant removal as both a liquid-phase scavenger and a solid-phase scavenger as follows:

Liquid-Phase Scavenger

1. A soluble support is prepared as described above, containing from 0.01 to 10% of the humic derivative, and is added to a liquid mixture of contaminants or biologically active compounds.
2. Silica gel (or other solid mineral support) is added to the target mixture containing the soluble HS derivative support.
3. The resultant suspension is mixed for about 4 to about 24 hours.
4. The silica gel with sequestered humic derivative liquid support and bound contaminants is separated using filtration.

Solid-Phase Scavenger

1. A target contaminant mixture is added with solid humic scavenger obtained as described above.
2. The solution is mixed for about 1 to about 120 hours, preferably from about 12 to about 48 hours, most preferably from about 24 to about 36 hours.
3. The solid humic scavenger with the bound components is separated from solution using filtration.

Our invention is further described, but not limited to, in the following examples.

### EXAMPLE 1

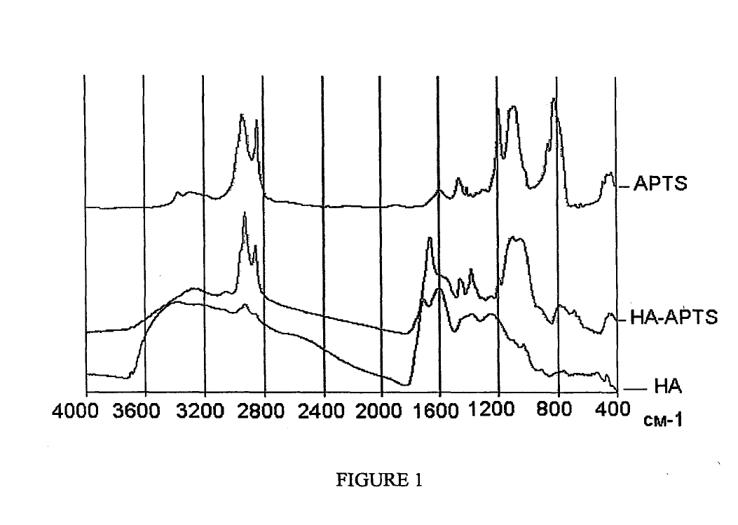

Examples 1-3 describe syntheses of the novel humic derivatives. The composition and structure of the obtained derivatives are confirmed using elemental analysis, titrimetry, MK and ¹³C NMR-spectroscopy. The data on elemental and functional composition of the obtained derivatives are given in Tables 2-7, FTIR and ¹³C NMR spectra are shown in FIGS. 1-4.

This example describes synthesis of alkoxysilyl-humic derivative using organosilane carrying amino-functional group and leonardite humic acids in protonated form as starting material. The reaction was carried out in a three neck reaction vessel equipped with a stirrer, a thermometer, and a reflux condenser. A weight of leonardite humic acid (1 g) was placed into the reaction vessel and added with 60 mL of dimethylformamide (DMF), and then added dropwise under continued stirring with 1 mL of 3-amino-propyltrimetoxy-silane (APTS). The given molar ratio of reagents accounted for 1:1, while 1 g of HS used contained 3.6 mmol of carboxyl groups which reacted with APTS; and 1 mL of APTS corresponded to 3.9 mmol of amino-groups. Reaction was carried out for 20 hours at 120° C. in dry atmosphere. When the reaction was completed, DMF was evaporated, and the obtained derivative was dried in a vacuum oven (40° C., 1 mbar). The obtained derivative was then homogenized and stored in a desiccator. The yield of the derivative was 1.95 g.

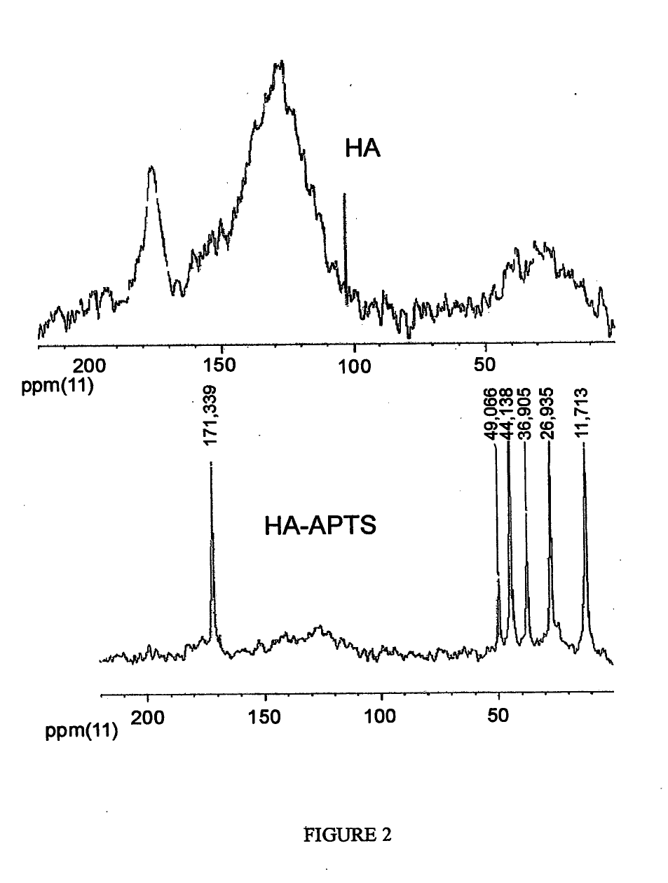

Structure of the obtained derivative was determined using elemental analysis and titration (data are shown in Tables 2 and 3), as well as by FTIR and ¹³C NMR spectroscopy. The corresponding spectra are given in FIGS. 1 and 2.

TABLE 2
Elemental composition on ash free basis (% mass) of
parental and APTS-treated humic materials from leonardite

| Sample | C | H | N | Si |
|---|---|---|---|---|
| Leonardite HA | 59.0 | 4.31 | 1.24 | 2.11 |
| HA-APTS | 61.8 | 7.40 | 6.72 | 8.25 |

TABLE 3
Content of acidic groups in parental leonardite HA and
its APTS-derivative (mmol/g)

| | Total acidity (TA) | —COOH | Ar—OH = |
|---|---|---|---|
| Sample | Cₐᵥₑ ± ΔC* | Cₐᵥₑ ± ΔC | TA − COOH |
| Leonardite HA | 5.6 ± 0.1 | 3.5 ± 0.1 | 2.1 |
| HA-APTS | 1.1 ± 0.1 | 0.3 ± 0.1 | 0.8 |

*ΔC - confidence interval, n = 3, P = 0.95.

The data of elemental analysis show a substantial increase in the content of N and Si in the obtained derivative. The data of titrimetry show a substantial decrease in the content of carboxylic groups in the APTS-derivative. The given changes confirm high modification degree of carboxylic groups of the parental humic material.

We have found that a typical APTS-treated leonardite humic acid compound will comprise from about 4 to about 10 wt. % Si, about 50 to about 68 wt. % C, about 6 to about 10 wt. % H, and about 4 to about 8 wt. % N, wherein the compound is able to react with hydroxyl-carrying surfaces forming covalent Si—O—Si or Si—O-M bonds, where M is a hydroxyl-carrying metal of mineral surface.

The following assignments can be made in FTIR spectrum of the parental material (FIG. 1): bands of C═C groups (1610 cm⁻¹) indicate the presence of aromatic moieties in HA; band at 1710 cm⁻¹ can be assigned to C═O bond of COOH and CO groups; band at 1250 cm⁻¹ can be assigned to C—O bonds in phenolic and carboxylic groups, and band at 1050-1150 cm⁻¹—to C—O bonds in alcoholic groups. The listed bands indicate presence of different oxygen-containing functional groups in the parent HS material. The bands missing in the parental humic material, but present in the FTIR spectrum of the modified humic material (HA-APTS) were assigned as follows: 1090-1020 cm⁻¹—Si—O—C groups, 2940-2845 cm⁻¹—(—CH₂)— groups, 1690 cm⁻¹—Shiff bases, 3360-3180 cm⁻¹ and 1400 cm⁻¹—amide bonds.

Peak assignments made for ¹³C NMR spectra of modified humic materials (HA-APTS) are as follows: 36 ppm—CH₃O groups linked to Si atoms; 11 ppm—Si-substituted C atoms of propyl chain, 24 ppm—C-substituted C atoms of propyl chain; 42 ppm—N-substituted C atom of propyl chain, 170 ppm—double-bond of N-substituted carbon atom of Shiff base, 185-220—C atoms of amide and residual carboxyl groups. See FIG. 2.

### EXAMPLE 2

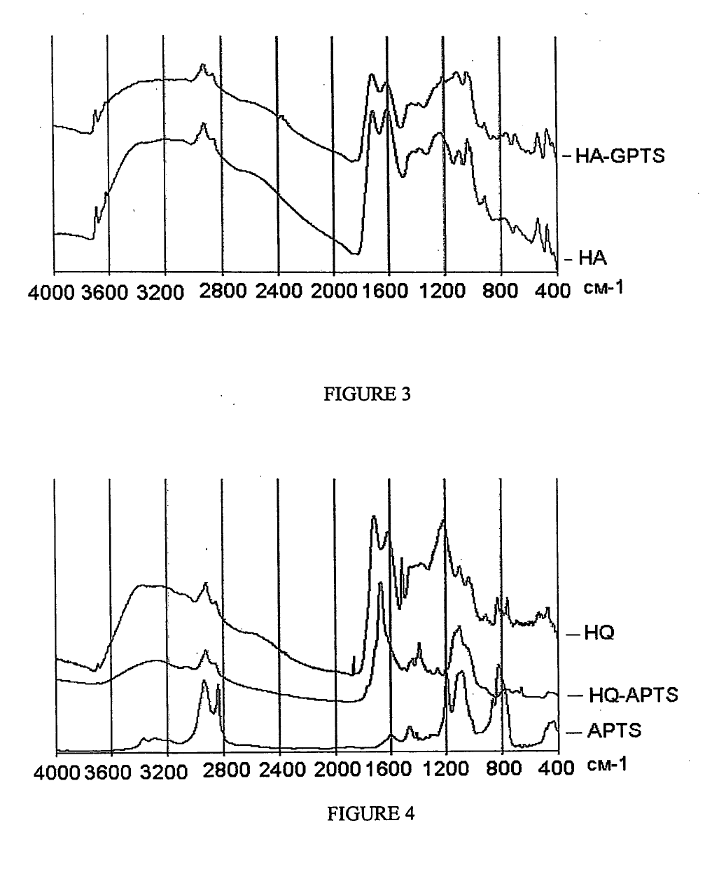

This example describes synthesis of alkoxysilyl-humic derivatives using organosilane carrying epoxy-group and potassium salt of leonardite humic acids as starting humic material. The same reactor was used as described in Example 1. 3-glycidoxy-propyltrimethoxy-silane (GPTS) (1.1 mL) was added to suspension, which consisted of 1 g of solid humate (K+) and 50 mL of dimethylsulfoxide (DMSO). The reaction was carried out for 10 hours at 40° C. After the reaction was completed, DMSO was vacuum evaporated. The obtained derivative was dried in a vacuum oven (40° C., 1 mbar). Yield of the reaction product was 1.81 g. The product was stored in desiccator. Structure of the obtained derivative was confirmed using elemental analysis and titration (Tables 4 and 5), and FTIR spectroscopy (FIG. 3).

TABLE 4
Elemental composition on ash free basis (% mass) of
parental and GPTS-treated humic materials from leonardite

| Sample | C | H | N | Si |
|---|---|---|---|---|
| Potassium humate (leonardite) | 57.4 | 4.22 | 1.68 | 1.32 |
| GPTS-HA | 54.4 | 5.03 | 1.39 | 4.87 |

TABLE 5
Content of acidic groups in parental humic material and
its GPTS-derivative (mmol/g)

| | Total acidity (TA) | —COOH | Ar—OH = |
|---|---|---|---|
| Sample | Cₐᵥₑ ± ΔC* | Cₐᵥₑ ± ΔC | TA − COOH |
| Potassium humate | 5.6 ± 0.1 | 3.5 ± 0.1 | 2.1 |
| (leonardite) | | | |
| GPTS-HA | 5.2 ± 0.1 | 3.5 ± 0.1 | 1.7 |

*ΔC - confidence interval, n = 3, P = 0.95

The data of elemental analysis show a substantial increase in Si. The data on acidic group contents show a decrease in the content of aromatic hydroxyls that indicates their modification by GPTS. The difference between spectra of modified and parent HA are bands at 1220 and 3670 cm⁻¹. They can be assigned to phenolic hydroxyls (Ar—OH): they are present in the non-modified sample and disappear in the modified sample.

### EXAMPLE 3

This example describes alkoxysilylation of hydroquinone-enriched leonardite humic acids (HQ). HQ is the product of formaldehyde condensation of leonardite HA with hydroquinone obtained as described in Perminova et al. (2005). The HQ is enriched with hydroquinone moieties as compared to HA. 3-aminopropyltrimethoxysilane (APTS) (0.4 mL) was added to suspension of 0.4 g of solid hydroquinone-enriched HA (HQ) in 40 mL of DMF. The reaction was carried out for 20 hours at 120° C. Then DMF was vacuum-evaporated and the obtained product was dried in vacuum oven (40° C., 1 mbar). Yield of the product was 0.68 g. Structure of the obtained derivative was studied using elemental analysis and titration (Tables 6 and 7), and FTIR spectroscopy (FIG. 4).

The data on elemental composition show a substantial increase in Si content in the derivative as compared to the parental material; the data on functional group composition show a substantial decrease in both carboxylic and total acidity in the derivative as compared to the parental material. The given changes indicate a high degree of modification of functional groups of humic materials due to the treatment with APTS. The obtained derivative was characterized with enhanced redox capacity and content of alkoxy-groups in its structure. In FTIR-spectrum (see FIG. 4), bands at 1190 and 1340 cm⁻¹ can be assigned to C—O bonds in phenol groups. All IR characteristics, described in example 2 for HA-APTS, are valid for HQ-APTS.

TABLE 6
Elemental composition on ash free basis (% mass) of
initial and APTS-treated hydroquinone-enriched humic
materials from leonardite

| Sample | C | H | N | Si |
|---|---|---|---|---|
| Hydroquinone enriched HA - HQ | 67.7 | 6.64 | 1.27 | 0.65 |
| HQ-APTS | 32.4 | 3.35 | 6.24 | 4.57 |

TABLE 7
Content of acidic groups in hydroquinone-enriched
humic materials (HQ) and its APTS-derivative
(HQ-APTS) (mmol/g)

| | Total acidity (TA) | —COOH | Ar—OH = |
|---|---|---|---|
| Sample | Cₐᵥₑ ± ΔC* | Cₐᵥₑ ± ΔC | TA − COOH |
| Hydroquinone enriched | 8.2 ± 2.9 | 4.3 ± 0.3 | 4.0 |
| HA - HQ | | | |
| HQ-APTS | 0.9 ± 0.1 | 0.3 ± 0.1 | 0.6 |

*ΔC - confidence interval, n = 3, P = 0.95.

### EXAMPLE 4

This example describes preparation of a liquid-phase scavenger and demonstrates its application in the model system “water-silica gel.” All obtained derivatives are soluble in water after their soaking with concentrated alkali. For this purpose, the samples are homogenized and added with 3-5-fold volume of concentrated NaOH or KOH. Then, the samples are diluted until the desired concentration (0.01-10%). The obtained solutions can be used per se as soluble support or for preparing solid support. Both liquid and solid humic supports can be used as scavengers for sequestering contaminants from solution. To prepare the solid support, silica gel or other solid carrier is added to the solution of alkoxy-derivatives of HS. Upon hydrolysis of alkoxysilyl-groups, reactive silanol-groups form firm Si—O—Si or Si—O-M bonds with hydroxyl-carrying surfaces.

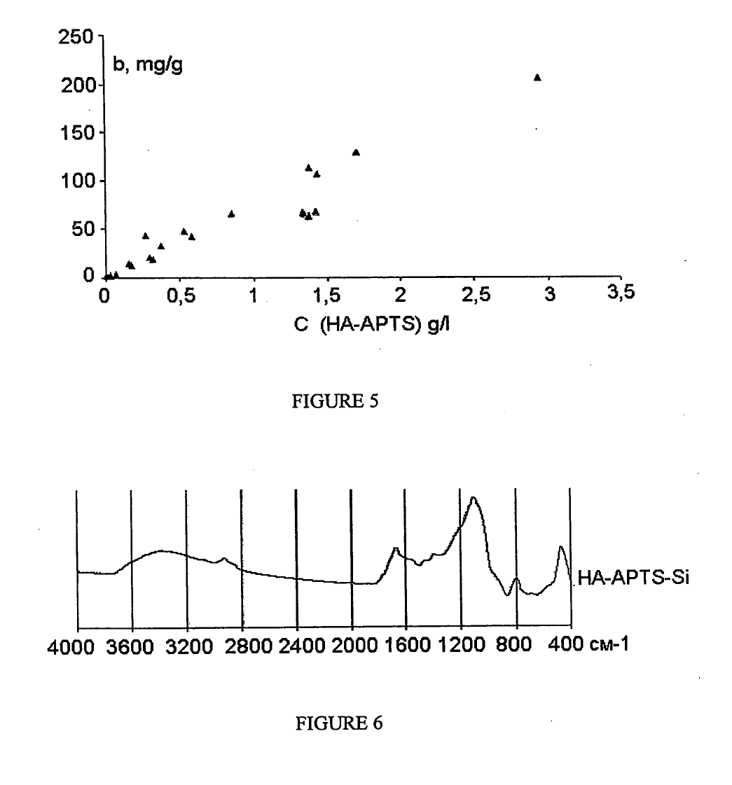

Capability of alkoxysilyl-derivatives to be removed from the solution in the presence of solid support was demonstrated on the example of APTS-derivative of leonardite HA and silica gel and shown in FIG. 5. For this purpose, the solutions of APTS-HA were prepared in the range of concentrations from 0.01 up to 5 g/L in phosphate buffer at pH 6.8 and added with the same weight of silica gel—0.1 g. After 24 hours, the content of HS remaining in solution was measured. A typical adsorption isotherm is shown in FIG. 5. Maximum sorption capacity of HS on silica gel was 150 mg per 1 g SiO₂. HA-APTS derivative sorption on silica gel was irreversible. It was proven by analysis of the silica gel coated with immobilized HA-APTS derivatives before and after washing with distilled water. It was shown that the content of organic carbon in the initial HA-APTS-silica gel (9.23%) was equal to that in the HA-APTS-silica gel manifold washed with distilled water (9.17%). Hence, sorption of alkoxysilyl-humic derivatives on silica gel is irreversible.

### EXAMPLE 5

This example describes preparation of solid-phase humic scavengers using alkoxysilyl-derivatives of native and hydroquinone-enriched humic acids from leonardite.

To prepare solid-phase humic scavengers, aqueous solutions of either HA-APTS or HQ-APTS at concentrations of 5 g/L (10 mL) were added with 0.1 g of silica gel and mixed for 24 hours. The silica gel with immobilized APTS-derivatives was centrifuged and washed with distilled water. The content of carbon in HA-APTS-SiO₂ (HA-APTS, immobilized on silica gel) was 9.2% mass, and in HQ-APTS-SiO₂ (HQ-APTS, immobilized on silica gel)—3.3% mass. The structure of obtained solid humic scavengers—HA-APTS derivatives immobilized on SiO₂—was characterized using FTIR spectroscopy (FIG. 6). FTIR-spectra of HA-APTS-SiO₂ exhibited bands typical to HA-APTS and SiO₂. Bands at 2940-2845 cm⁻¹ were assigned to (—CH₂—) groups, Shiff bases were displayed as peaks at 1690 cm⁻¹. Amide bonds were displayed at 1400 and 3360-3180 cm⁻¹.

### EXAMPLE 6

This example describes an application of the solid-phase scavengers for sequestration of actinides (neptunium) from solution.

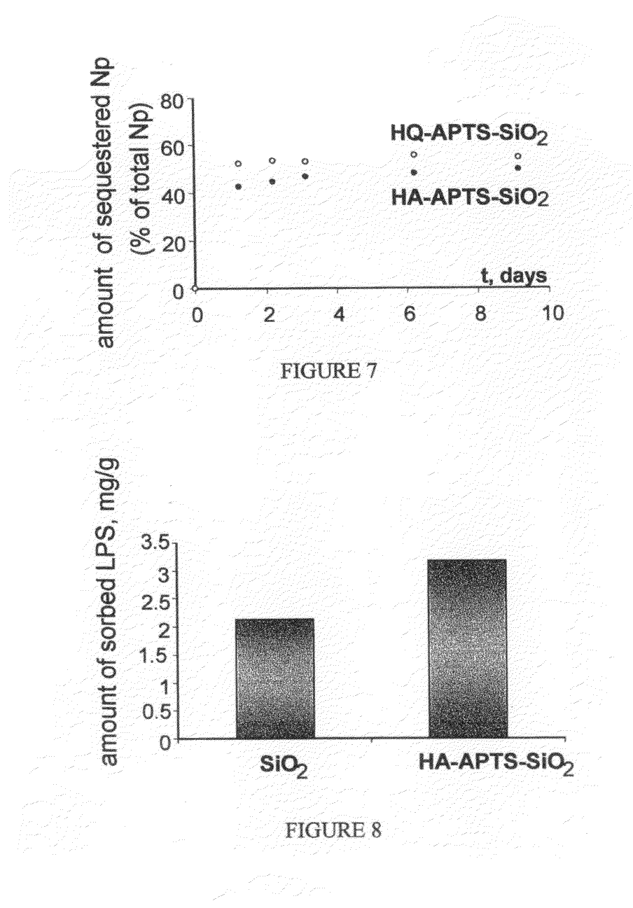

The solid-phase scavengers prepared as described in Example 5, were used for sequestering neptunium(V) from solution. Scavenger I was prepared using HA-APTS, and scavenger II—using HQ-APTS. The experiments were conducted under anoxic conditions in the dark in the glovebox. Solution of Np(V) at concentration of 3.5·10⁻⁵ M (20 mL) was added with 40 or 70 mg of solid scavengers I or II, respectively, and adjusted to pH 4.5. The prepared solutions were sampled at certain time periods over in total 9 days long exposure. The content of Np(V) in the solution was determined using extraction with HDEHP followed by liquid scintillation counting as described by Morgenstern and Choppin (2002). The obtained results are shown in FIG. 7. FIG. 7 shows the sequestration kinetics of Np(V) in the presence of solid scavenger I (HA-APTS-SiO2) containing not enriched leonardite HA and of scavenger II (HQ-APTS-SiO₂) containing hydroquinone enriched leonardite HA at pH 4.5. As it can be seen from the shown kinetic curves, both solid scavengers efficiently sequester Np(V) from solution with efficiency of hydroquinone-enriched scavenger II being higher, as compared to that of non-enriched scavenger I.

### EXAMPLE 7

This example describes an application of the solid-phase scavengers for sequestration of bacterial endotoxin (lipopolysaccharide) from solution.

The solid scavenger I prepared as described in Example 5 and containing HA-APTS was used to sequester lipopolysaccharide (LPS)—endotoxin of gramm-negative bacteria from solution. LPS was determined using reaction with carbocyanine dye that leads to formation of complex with characteristic absorbance maximum at 450-478 nm. FIG. 8 shows the sequestration of LPS by solid humic scavenger I (HA-APTS-SiO2) as compared to pure silica gel. As it can be seen, scavenger I has much higher sequestering ability with respect to LPS as compared to pure silica gel.

The foregoing description of the specific embodiments will so fully reveal the general nature of the invention that others can, by applying current knowledge, readily modify and/or adapt for various application such specific embodiments without departing from the generic concept, and therefore such adaptations and modifications are intended to be comprehended within the meaning and range of equivalents of the disclosed embodiments. It is to be understood that the phraseology or terminology herein is for the purpose of description and not of limitation.

The means, materials, and steps for carrying out various disclosed functions may take a variety of alternative forms without departing from the invention. Thus, the expressions “means to . . . ” and “means for . . . ”, or any method step language as may be found in the specification above or the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same function can be used; and it is intended that such expressions be given their broadest interpretation.

All references cited in this specification are hereby incorporated by reference.

1. A humic derivative compound comprising about 2 to about 12 wt. % Si, about 25 to about 68 wt. % C, about 2 to about 10 wt. % H, about 0 to about 15 wt. % N, and about 0.1 to about 15 mmol/g alkoxysilyl-groups, wherein the humic derivative compound is able to react with hydroxyl-carrying surfaces forming covalent Si—O—Si or Si—O-M bonds, where M is a hydroxyl-carrying metal of a mineral surface.

2. (canceled)

3. A APTS-treated leonardite humic acid compound comprising about 4 to about 10 wt. % Si, about 50 to about 68 wt. % C, about 6 to about 9 wt. % H, about 4 to about 8 wt. % N, and about 0.1 to about 15 mmol/g alkoxysilyl-groups, wherein the compound is able to react with hydroxyl-carrying surfaces forming covalent Si—O—Si or Si—O-M bonds, where M is a hydroxyl-carrying metal of mineral surface.

4. (canceled)

5. A humic derivative compound according to claim 2, characterized in that that the alkoxysilyl-groups are: where n=1, 2, 3; m+n=3; R₁—a functionalized organic moiety capable of reacting with carbonyl, hydroxyl, carboxyl and amino groups; R₂-Ci-C₁O (linear or branched alkanes); and R₃—CH₃.

6. A humic derivative compound according to claim 5, where R₂=CH₃ or C₂Hk.

7. The humic derivative compound according to claim 2, characterized in that that they have trimethoxysilyl- or triethoxysilyl- as the alkoxysilyl-groups.

8. Humic derivative compounds according to claim 1, wherein the hydroxyl-carrying metal of the mineral surface is selected from the group consisting of Al, Fe, Cr, Ti, and mixtures thereof.

9. A method of preparing a humic derivative comprising the following steps in combination, a) providing a humic substance comprising about 20 to about 70 wt. % C, about 2 to about 10 wt. % H₅ about 15 to about 55 wt. % O, and about 0 to about 10 wt. % N, and about 0 to about 50 wt. % ash; b) reacting the humic substance with an organosilane of the following formula:
R₁—Si(R₃)ₘ—(OR₂)
where n=1, 2, 3; m+n=3; Ri—a functionalized organic moiety capable of reacting with carbonyl, hydroxyl, carboxyl and amino groups; R₂-Ci-Cio (linear or branched alkanes); and R₃—CH₃.

10. A method of preparing a humic derivative according to claim 9, where R₂=CH3 or C₂H₅.

11. A method of preparing a humic derivative according to claim 9, where n=3 and m=0.

12. A method of preparing humic derivatives according to claim 9, where Ri is selected from the group consisting of a 3-aminopropyl group, a 3-glycidoxypropyl group, and a 3-isocyanate-propyl group.

13. A humic-based scavenger comprising, a) about 0.01 to about 10 wt. % of a humic derivative compound comprising about 2 to about 12 wt. % Si, about 25 to about 68 wt. % C, about 2 to about 10 wt. % H, and about 0 to about 15 wt. % N; and about 0.1 to about 15 mmol/g alkoxysilyl-groups; b) a solvent selected from the group consisting of water, water with salt, alkali, acid admixtures, an organic and mixtures thereof.

14. A humic-based scavenger comprising,
a) about 0.5 to about 25 wt. % of a humic derivative compound comprising about 2 to about 12 wt. % Si, about 25 to about 68 wt. % C, about 2 to about 10 wt. % H, and about 0 to about 15 wt. % N; and about 0.1 to about 15 mmol/g alkoxysilyl-groups; b) silica gel or other hydroxyl-carrying solid support.

15. A method for preparing a humic-based scavenger comprising in combination the following steps:
a) providing a solid humic derivative compound comprising about 2 to about 12 wt. % Si, about 25 to about 68 wt. % C, about 2 to about 10 wt. % H, and about 0 to about 15 wt. % N; and about 0.1 to about 15 mmol/g alkoxysilyl-groups
b) dissolving the solid humic derivative with an alkali; and
c) diluting the dissolved humic derivative with water or water with admixtures of salts or organic solvent.

16. A method of preparing a humic-based scavenger comprising in combination the following steps,
a) providing a humic derivative compound comprising about 2 to about 12 wt. % Si, about 25 to about 68 wt. % C, about 2 to about 10 wt. % H, and about 0 to about 15 wt. % N; and about 0.1 to about 15 mmol/g alkoxysilyl-groups
b) dissolving the solid humic derivative with an alkali;
c) diluting the dissolved humic derivative with water or water with admixtures of salts or organic solvent
d) contacting the humic derivative in a liquid phase with silica gel or other hydroxyl-carrying solid support to yield a solid product and a residual liquid; and
e) separating the solid product from d) from the residual liquid phase from step c).

17. The method of claim 16 wherein the humic derivative is contacted with the silica gel or other hydroxyl-carrying solid support for about 4 to about 120 hours.

18. A method of sequestering dissolved components having preferential affinity for humic substances comprising in combination the following steps, a) providing a liquid containing dissolved components having preferential affinity for humic substances; b) sequestering the dissolved component by contacting the dissolved components with a humic-based scavenger comprising,
i) about 0.01 to about 10 wt. % of a humic derivative compound comprising about 2 to about 12 wt. % Si, about 25 to about 68 wt. % C, about 2 to about 10 wt. % H, and about 0 to about 15 wt. % N, and about 0.1 to about 15 mmol/g alkoxysilyl-groups, and ii) water or an organic solvent to form an admixture; and c) adding a hydroxyl-carrying solid support to the admixture formed in step b) to remove the sequestered dissolved components.

19. A method of sequestering dissolved components having preferential affinity for humic substances comprising in combination the following steps, a) providing a liquid containing dissolved components having preferential affinity for humic substances; b) sequestering the dissolved components by contacting the dissolved components with a humic-based scavenger comprising, i) about 0.5 to about 25 wt. % of a humic derivative compound comprising about 2 to about 12 wt. % Si, about 25 to about 68 wt. % C, about 2 to about 10 wt. % H, and about 0 to about 15 wt. % N, and about 0.1 to about 15 mmol/g alkoxysilyl-groups, and ii) silica gel or other solid mineral support to form an admixture; c) separating the sequestered dissolved solids from the admixture formed in step b).

20. An in situ reactive barrier located underground comprising a humic derivative compound immobilized onto mineral support, where the humic derivative compound comprises about 2 to about 12 wt. % Si, about 25 to about 68 wt. % C, about 2 to about 10 wt. % H, and about 0 to about 15 wt. % N, and about 0.1 to about 15 mmol/g alkoxysilyl-groups, wherein the immobilized humic derivative compound prevents contaminants from spreading outside a pre-defined contamination zone.

21. A method of forming an in situ reactive barrier comprising in combination the following steps, a) identifying a zone of contamination within bed sediments of a water body, within a vadose zone, or within an aquifer; b) providing a water solution of a humic derivative compound, where the humic derivative compound comprises about 2 to about 12 wt. % Si, about 25 to about 68 wt. % C, about 2 to about 10 wt. % H, and about 0 to about 15 wt. % N, and about 0.1 to about 15 mmol/g alkoxysilyl-groups; and c) introducing a water solution of humic derivative either within or near the zone of contamination located in the bed sediments of the water body, the vadose zone, or the aquifer using wells or a surface irrigation system so as to prevent contaminants from spreading and enlarging the contamination zone.

22. The method of claim 21 wherein the humic derivative compound is provided as its 0.01 to about 10 wt. % water solution.

23. An in situ reactive barrier to prevent the spread of underground contaminants based on humic derivative substances formed by the process of claim 21.

24. A humic derivative compound according to claim 4, characterized in that that the alkoxysilyl-groups are: where n=1, 2, 3; m+n=3; R₁—a functionalized organic moiety capable of reacting with carbonyl, hydroxyl, carboxyl and amino groups; R₂-Ci-C₁O (linear or branched alkanes); and R₃—CH₃.

25. The humic derivative compound according to claim 4, characterized in that that they have trimethoxysilyl- or triethoxysilyl- as the alkoxysilyl-groups.

26. Humic derivative compounds according to claim 3, wherein the hydroxyl-carrying metal of the mineral surface is selected from the group consisting of Al, Fe, Cr, Ti, and mixtures thereof.
